(19) United States
(12) Patent Application Publication
(10) Pub. No.: US 2017/0158368 A1
(43) Pub. Date: Jun. 8, 2017

(54) Increasing stack strength using crisscross risers

(71) Applicant: Alain Cerf, Redding Beach, FL (US)

(72) Inventor: Alain Cerf, Redding Beach, FL (US)

(21) Appl. No.: 15/368,918

(22) Filed: Dec. 5, 2016

Related U.S. Application Data
(60) Provisional application No. 62/264,835, filed on Dec. 8, 2015.

(51) Int. Cl. B65B 61/20; B65B 65/00; B65B 53/02; B65B 35/30; B65G 15/00; B65G 47/82

(52) U.S. Cl. CPC B65B 61/207; B65G 15/00; B65G 47/82; B65B 53/02; B65B 35/30; B65B 65/003

(57) ABSTRACT

This invention solves the problem in the prior art when a bundle of containers lack sufficient strength to support at least three or more bundles to be stacked on a pallet having at least four bundles high. The invention solves the problem by increasing the stacking strength of a bundle of containers by using crisscrossed cardboard risers.

### FIELD OF INVENTION

This invention relates to increasing the stacking strengths of a bundle of articles wrapped in heat shrink material wherein the articles cannot support more than one or two bundles on top of each other.

### BACKGROUND OF THE INVENTION

Cardboard board risers have been placed between rows of glass bottles in a corrugated box to avoid glass breakage. The risers can be placed between the bottles in a crisscross manner. These boxes rely on the bottle strength for stacking the boxes of bottles on top of each other not the risers. Cardboard risers have been used with milk cartons with gable tops to increase stack strength. These risers have been limited to using one riser or two risers placed parallel to each other. These bundles containing milk cartons using these risers have not been able to vertically support more than two bundles. The problem in the prior art was the inability to stack a bundle of containers lacking sufficient strength to support at least three or more bundles so the bundles could be stacked on a pallet having at least four bundles high.

### SUMMARY OF THE INVENTION

The objective of this invention is to increase the stacking strength of a bundle of containers by using crisscrossed cardboard risers between each container. For a four pack there would be two risers. For a six pack there would be two short parallel risers and one long riser perpendicular to the parallel cardboard risers. For a twelve pack there would be three lanes of four containers with at least two parallel risers and two perpendicular risers. More risers can be added if desired.

### BRIEF DESCRIPTION OF THE DRAWINGS

FIG. 1 shows a bundle of six milk cartons with spaces between the cartons for the insertion of risers.

FIG. 2 shows a bundle with risers inserted.

FIG. 3 shows a bundle of milk cartons with inserted risers.

FIG. 4 shows moving spaced containers in a lane for the insertion of risers

FIG. 5 shows conveyors for moving the containers.

FIG. 6 shows a transfer pusher moving the containers after the risers are inserted

### DESCRIPTION OF THE INVENTION

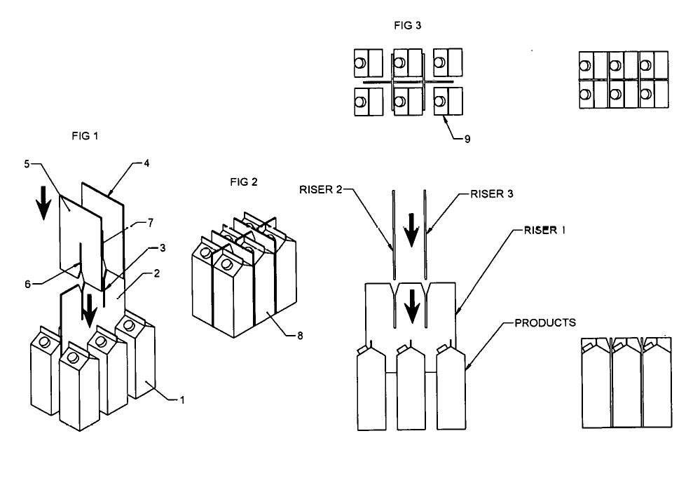

FIG. 1 shows a bundle of six milk cartons 1 with a space between the cartons. Cardboard riser 2 is inserted between three of the milk cartons. Cardboard 2 has openings 3 to mate with openings 6 and 7 in cardboard risers 4 and 5. FIG. 2 shows Cardboard risers 4 and 5 inserted between two of the milk cartons to form bundle. FIG. 3 shows a bundle 9 having spaced milk cartons with the inserted mated risers. The risers are substantially the same height as the milk cartons. Any material that provides the desired stack strength to the bundle can be used as the riser.

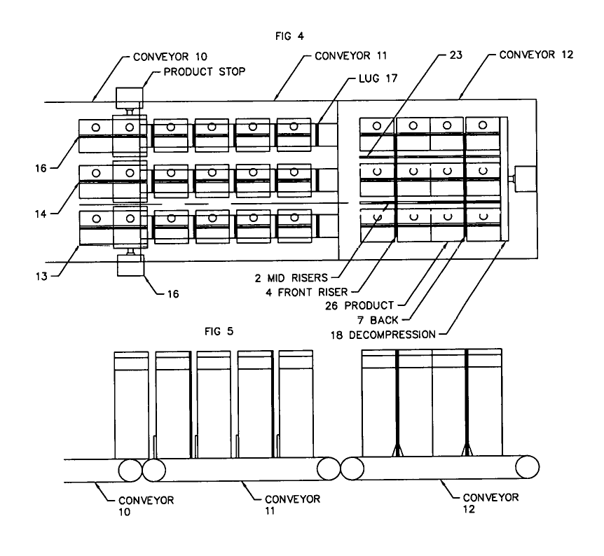

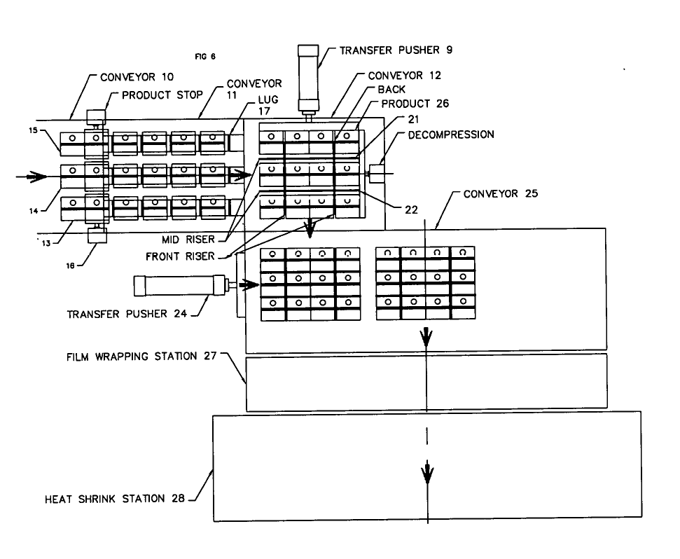

FIGS. 4 and 5 show belt conveyors 10, 11, and 12 moving the containers in lane 13. Lanes 14 and 15 have identical conveyors to move the containers. Lanes 10, 11 and 12 are spaced apart to allow a riser to be inserted between the containers. Stopping means such as a clamp 16 on lane 13 releases the containers in spaced intervals on to conveyor 11 to provide sufficient room for inserting the risers between the containers. Narrow lugs 17 attached to conveyor 11 maintain the conveyors at the desired spacing. Conveyor 11 transports the containers onto conveyor 12. Conveyor 12 moves the bottles against decompression plate 18 to close the space between the containers. Before the space between the containers are closed, the conveyors 11 and 12 stop to allowing to insertion of risers 4 and 7. After riser 4 and 7 are inserted, risers 2 and 23 are inserted. After the risers are inserted the conveyors start, causing the space between risers 4 and 7 to close.

FIG. 6 shows transfer pusher 19 pushing the containers off conveyor 12 onto conveyor 20. During the transfer the spaces 21 and 22 are closed. Transfer pusher 24 centers the bundle on conveyor 25. Conveyor 25 moves the product 26 to a film wrapping station 27. After the product is film wrapped the product moves through a heat shrink tunnel 28. The heat shrunk product is stacked on a pallet with at least four products on top of each other.

1. A process for increasing the stack strength of a bundle of containers that cannot support more than two bundles on top of a base bundle comprising,
inserting a first riser between the containers wherein the first riser has an opening to mate with an opening in a second riser,
inserting the second riser having an opening to mate with the opening in the first riser between the containers in a direction perpendicular to the first riser to form a crisscross,
wrapping the bundle with heat shrinkable film
heat shrinking the film, and
stacking the bundle on a pallet.

2. A process according to claim 1 including moving at least two lanes of containers wherein each container in the lane is spaced a predetermined distance apart containers onto a conveyor where the containers can be stopped from moving.

3. A process according to claim 2 including stopping the conveyor and inserting a riser in the space between the containers in each lane and inserting a rise between two lanes.

4. A process according to claim 1 wherein the containers are milk cartons.

5. A process according to claim 3 including starting the conveyor after the risers are inserted to close the spaces between the containers in a lane.

6. A process according to claim 5 including closing the space between the containers in each lanes.

7. A process for increasing the stack strength of a bundle of containers that cannot support more than two bundles on top of a base bundle comprising,
moving at least two separated lanes of containers having a predetermined space between the lanes and wherein each container in the lane is spaced a predetermined distance apart onto a conveyor where the containers can be stopped from moving
stopping the conveyor and inserting a first riser in the space between the containers in each lane wherein the first riser has an opening to mate with an opening in a second riser,
inserting the second riser having an opening to mate with the opening in the first riser between the containers in a direction perpendicular to the first riser to form a crisscross,
starting the conveyor after the first risers are inserted to close the spaces between the containers in a lane.
closing the space between the containers in each lanes,
wrapping the bundle with heat shrinkable film, and
heat shrinking the film.

8. An Apparatus for increasing the stack strength of a bundle of containers that cannot support more than two bundles on top of a base bundle comprising,
means for moving at least two separated lanes of containers having a predetermined space between the lanes and wherein each container in the lane is spaced a predetermined distance apart onto a conveyor where the containers can be stopped from moving means for stopping the conveyor and inserting a first riser in the space between the containers in each lane wherein the first riser has an opening to mate with an opening in a second riser,
means for inserting the second riser having an opening to mate with the opening in the first riser between the containers in a direction perpendicular to the first riser to form a crisscross,
means for starting the conveyor after the first risers are inserted to close the spaces between the containers in a lane.
means closing the space between the containers in each separated lanes,
means for wrapping the bundle with heat shrinkable film, and
means for heat shrinking the film.
